(19) United States
(12) Patent Application Publication
(10) Pub. No.: US 2008/0094529 A1
(43) Pub. Date: Apr. 24, 2008

(54) Adaptive Sun Visor

(76) Inventors: Fan He, Gurnee, IL (US); Long He, Beijing (CN); Zhaozhi Mei, Jinan (CN)

Correspondence Address: MCANDREWS HELD & MALLOY, LTD, 500 WEST MADISON STREET, SUITE 3400, CHICAGO, IL, 60661, US

(21) Appl. No.: 11/573,684

(22) PCT Filed: Jun. 8, 2005
(86) PCT No.: PCT/CN05/00805

§ 371 Date: Aug. 20, 2007

(30) Foreign Application Priority Data
Aug. 13, 2004 (CN) 20040087790.3

(51) Int. Cl. G02F 1/133

(52) U.S. Cl. 349/16

(57) ABSTRACT

This invention discloses an adaptive sun visor, which has a microcontroller (2), a keypad (4), a photo sensor array assembly (1), and a liquid crystal panel (3), which comprises a number of pixels. The microcontroller (2) has interfaces to keypad (4), photo sensor array assembly (1), and liquid crystal panel (3). Microcontroller (2) reads the outputs of photo sensor array assembly (1) through its A/D channels, and microcontroller (2) activates pixels on the liquid crystal panel based on the outputs of photo sensor array assembly (2). The invented adaptive sun visor can prevent the vehicle driver from the disturbance of the offending light and thus the driver can safely operate the vehicle.

### FIELD OF THE INVENTION

This invention relates to sun visors, and more particularly, to adaptive sun visors with a transmission coefficient electronically controllable in photoelectrical field.

### BACKGROUND OF THE INVENTION

The sun visors on the cars and other vehicles are for the purpose to prevent the driver and the passenger from the offending sunlight and other disturbing light including the headlight from the incoming traffic. The prior sun visors used on the cars and other vehicles are made with opaque or semi-transparent materials to block or attenuate the disturbing light from the driver and passengers. Chinese patent No. ZL02160110.0 disclosed a visor that can be fixed conveniently and quickly and also has multiple functions. This visor includes visor clothes and rims that are arranged in wrapping clothes at edge of the visor clothes and formed by pliable metal or plastics, wherein the rims include at least a part of extruding rims out of the visor clothes and the area formed by the extruding rims is larger than the total area of the visor clothes. U.S. Pat. No. 5,530,572 disclosed an electronically controlled visor that can selectively block only the disturbing light, but its control method and pixel design can be further improved.

The problem of prior sun visors is that it will totally block the driver's view in the case where the disturbing light comes from the horizontal direction or by small angle like the sunlight in the early morning and late afternoon.

### SUMMARY OF THE INVENTION

The present invention discloses an adaptive visor, which may solve the problem that it may incur dazzle effect by clocking views of the driver when the disturbing light comes from horizontal direction or by small angle like the sunlight in the early morning and late afternoon.

The present adaptive sun visor includes a microcontroller 2, a keypad 4, a photo sensor array assembly 1 and a liquid crystal panel 3. The keypad 4, the photo sensor array assembly 1 and the liquid crystal panel 3 are connected with the microcontroller 2. The liquid crystal panel 3 composes of a number of pixels. The microcontroller 2 includes one or more A/D channels for reading outputs of the photo sensor array and activates the number of pixels one by one or group by group. The microcontroller 2 includes a general Input/Output, a serial communication interface, a reset input, an interrupt input and A/D channels. The microcontroller 2 has a plurality of general input/output (GPIO) terminals connectable to the keypad 4 for driving the liquid crystal panel 3. The photo sensor array assembly 1 includes any one of a vertical photo sensor array, a horizontal photo sensor array and a combination thereof. The photo sensor array assembly 1 includes plural A/D channels for reading outputs of the photo sensors. The photo sensor array assembly 1 may include an optical filter 11, a photosensitive glass 13, a cylindrical lens assembly 12, a linear photo sensor array 14, and an interface circuit 15 for the photo sensor array assembly connected to the microcontroller 2 and configured to send data into the microcontroller 2. The liquid crystal panel 3 has a passive matrix LCD driver that interfaces with the microcontroller 2 and drives the liquid crystal panel having 3 front planes and 16 back planes. Alternatively, the liquid crystal panel 3 may have an active matrix LCD driver that interfaces with the microcontroller 2 and drives the back panels and thin film liquid crystal panels with specific pixels. The number of pixels of the liquid crystal panel 3 are in a transparent state when they are not activated and in a semi-transparent state when activated. The front and back planes of the liquid crystal panel 3 have a substrate formed by laminated glass or plastics. The keypad 4 includes a mode selection key, a reset key, + keys and − keys.

By using the adaptive sun visor of the present invention, it can prevent the drivers from disturbing by the offending sunlight and keep fine views for the drivers, making driving safely.

### BRIEF DESCRIPTION OF THE DRAWINGS

FIG. 1 is a schematic block diagram showing the function of an adaptive sun visor according to an embodiment of the present invention;

FIG. 2 is a schematic diagram showing the structure of the photo sensor array according to an embodiment of the present invention;

FIG. 3 is a schematic diagram showing the state when using the current sun visor;

FIG. 4 is a schematic diagram showing the state when using the adaptive sun visor according to the present invention;

FIG. 5 is a schematic diagram showing the operation of the adaptive sun visor according to the present invention.

### DETAILED DESCRIPTION OF SEVERAL EMBODIMENTS

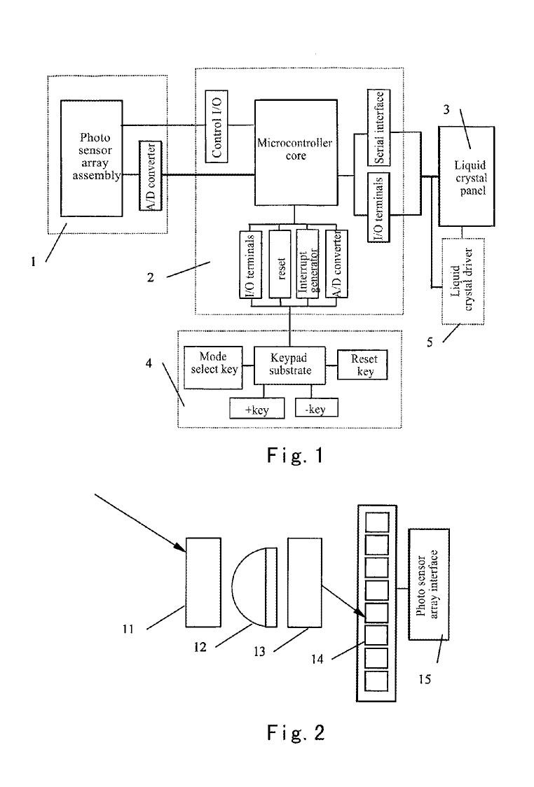

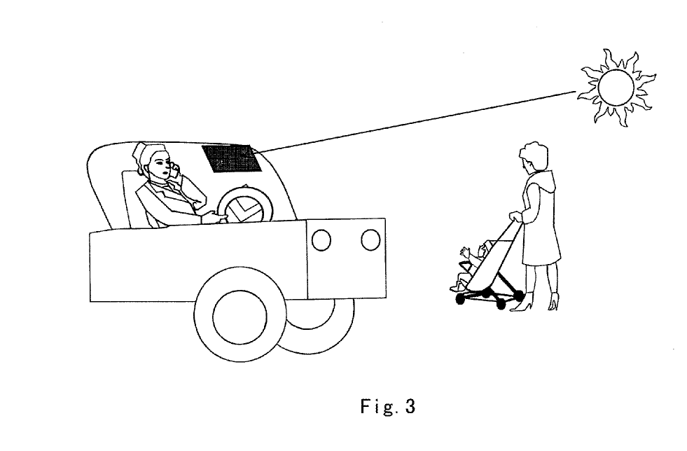

The adaptive sun visor according to several embodiments of the present invention will be described in detail with reference to FIGS. 1 and 2.

### Embodiment 1

### An Adaptive Sun Visor with Front Plane having Horizontal Strips

The adaptive sun visor of Embodiment 1 includes:
1. Liquid crystal panel 3, including a front plane of 16 horizontal strips and a back plane;
2. Photo sensor array 1 with 6 photo sensors to detect the vertical position of the incident light source;
3. Microcontroller 2, which has 22 or more general inputs/outputs (GPIOs), one reset input, one interrupt input and 8 A/D channels;
4. Keypad 4, which has a mode selection key, a “+” key, a “−” key and a reset key. The mode selection key allows the user to select one of the 7 operating modes. The + key allows the user to move up the activated strips, while the − key allows the user to move down the activated strips. The reset key allows the user to reset the adaptive sun visor to its default operating state by starting a control circuit.

Embodiment 1 can operate in the following modes:
1. Single strip mode. Microcontroller 2 only activates one horizontal strip in this mode.
2. Double strip mode. Microcontroller 2 activates two adjacent horizontal strips into the same transparency.
3. Triple strip mode. Microcontroller 2 activates three adjacent horizontal strips in this mode. In this mode, the center strip is driven to its lowest transparency based on the intensity of the incident light, while the other two strips are driven to 30% of transparency of the center strip.
4. Quadruple mode. Microcontroller 2 activates four adjacent horizontal strips in this mode. In this mode, the two center strips are driven to its lowest transparency based on the intensity of the incident light, while the other two strips are driven to 30% of transparency of the center strips.
5. Penta-mode. Microcontroller 2 activates five adjacent horizontal strips in this mode. In this mode, the center strip is driven to its lowest transparency based on the intensity of the incident light, the two strips adjacent to the center strip are driven to 20% transparency of the center strip, while the other two strips are driven to 50% of transparency of the center strip.
6. Six strip mode. Microcontroller 2 activates six adjacent horizontal strips in this mode. In this mode, the two center strips are driven to its lowest transparency based on the intensity of the incident light, the two strips adjacent to the two center strips are driven to 20% transparency of the center strips, while the other two strips are driven to 50% of transparency of the center strips.
7. Seven strip mode. Microcontroller 2 activates seven adjacent horizontal strips in this mode. In this mode, the center strip is driven to its lowest transparency based on the intensity of the incident light, the two strips adjacent to the two center strips are driven to 20% transparency of the center strip, the next two adjacent strips are driven to 40% transparency of the center strip, while the top and the bottom strips are driven to 60% of transparency of the center strip.

### Embodiment 2

### An Adaptive Sun Visor with Front Plane having Vertical Strips

The adaptive sun visor of embodiment 2 includes:
1. Liquid crystal panel 3, including a front plane of 32 vertical strips and a back plane;
2. Photo sensor array 1, having 12 photo sensors to detect the horizontal position of the incident light source and A/D channels with sufficient channels for reading input signals of the 12 photo sensors;
3. Microcontroller 2, which has 38 or more GPIOs, one reset input, one interrupt input and 8 A/D channels;
4. Keypad 4, which has a mode selection key, a “+” key, a “−” key and a reset key. The mode selection key allows the user to select one of the 7 operating modes. The + key allows the user to move up the activated strips, while the − key allows the user to move down the activated strips. The reset key allows the user to reset the adaptive sun visor to its default operating state by starting a control circuit.

Embodiment 2 can operate in the following modes:
1. Single strip mode. Microcontroller 2 activates two separate vertical strips in this mode.
2. Double strip mode. Microcontroller 2 activates two groups of vertical strips. Each group has two adjacent vertical strips that are driven to the same transparency.
3. Triple strip mode. Microcontroller 2 activates two groups of vertical strips. Each group has three adjacent vertical strips in this mode. In this mode, the center strip in each group is driven to its lowest transparency based on the intensity of the incident light, while the other strips are driven to 30% of transparency of the center strip.
4. Quadruple mode. Microcontroller 2 activates two groups of vertical strips. Each group has four adjacent vertical strips in this mode. In this mode, the two center strips in each group are driven to its lowest transparency based on the intensity of the incident light, while the other strips are driven to 30% of transparency of the center strips.
5. Penta-mode. Microcontroller 2 activates two groups of vertical strips. Each group has five adjacent vertical strips in this mode. In this mode, the center strip of each group is driven to its lowest transparency based on the intensity of the incident light, the two strips adjacent to the center strip are driven to 20% transparency of the center strip, while the other two strips are driven to 50% of transparency of the center strip.
6. Six strip mode. Microcontroller 2 activates two groups of vertical strips. Each group has six adjacent vertical strips in this mode. In this mode, the two center strips in each group are driven to its lowest transparency based on the intensity of the incident light, the two strips adjacent to the two center strips are driven to 20% transparency of the center strips, while the other two strips are driven to 50% of transparency of the center strips.
7. Seven strip mode. Microcontroller 2 activates two groups of vertical strips. Each group has seven adjacent vertical strips in this mode. In this mode, the center strip is driven to its lowest transparency based on the intensity of the incident light, the two strips adjacent to the two center strips are driven to 20% transparency of the center strip, the next two adjacent strips are driven to 40% transparency of the center strip, while the top and the bottom strips are driven to 60% of transparency of the center strip.

### Embodiment 3

### An Adaptive Sun Visor with a Passive Matrix Liquid Crystal Panel

The adaptive sun visor of embodiment 3 includes:
1. Liquid crystal panel 3, including a front plane with 32 vertical strips and a back plane with 16 horizontal strips;
2. Photo sensor array 1, having 12 horizontal photo sensors to detect the horizontal position of the light source and 6 vertical photo sensors to detect vertical position of the light source and having A/D channels with sufficient channels for reading input signals of the 18 photo sensors;
3. Microcontroller 2, which has 10 or more GPIOs, a serial communication interface, a reset input, an interrupt input and several A/D channels;
4. Passive LCD matrix driver 5, which has serial interfaces for communicating with the microcontroller 2 and activate two groups of pixels on the liquid crystal panel under the control of microcontroller 2.
5. Keypad 4, which has a mode selection key, a “+” key, a “−” key and a reset key. The mode selection key allows the user to select one of the 5 operating modes. The + key and − key allow the user to move up the activated pixels on the liquid crystal panel. The reset key allows the user to reset the adaptive sun visor to its default operating state by starting a control circuit. In the passive LCD matrix, two groups of pixels are activated based on the output information from the sensor array.

Embodiment 3 can operate in the following modes:
1. 3×3 mode. Microcontroller 2 activates two groups of pixels. Each group has 9 pixels arranged in 3 rows and 3 columns. The center pixel in each group is driven to its lowest transparency, while the other 8 pixels are driven to 30% transparency of the center pixel.
2. 4×4 mode. Microcontroller 2 activates two groups of pixels. Each group has 16 pixels arranged in 4 rows and 4 columns. The 4 center pixels in each group are driven to the lowest transparency of the center pixel, while the other 12 pixels are driven to 30% transparency of the center pixel.
3. 5×5 mode. Microcontroller 2 activates two groups of pixels. Each group has 25 pixels arranged in 5 rows and 5 columns. The center pixel in each group is driven to the lowest transparency, the 8 pixels adjacent to the center pixel are driven to 20% transparency of the center pixel, and the rest 16 pixels are driven to 40% transparency of the center pixel.
4. 6×6 mode. Microcontroller 2 activates two groups of pixels. Each group has 36 pixels arranged in 6 rows and 6 columns. The 4 center pixels in each group are driven to the lowest transparency, the 12 pixels adjacent to the 4 center pixels are driven to 20% transparency of the center pixel, and the rest 20 pixels are driven to 40% transparency of the center pixel.
5. 7×7 mode. Microcontroller 2 activates two groups of pixels. Each group has 49 pixels arranged in 7 rows and 7 columns. The center pixel in each group is driven to the lowest transparency, the 8 pixels adjacent to the center pixel are driven to 20% transparency, the next 16 pixels are driven to 40% transparency of the center pixel, and the rest 24 pixels are driven to 60% transparency of the center pixel.

### Embodiment 4

### An Adaptive Sun Visor with an Active Liquid Crystal Panel

The adaptive sun visor of embodiment 4 includes:
1. Liquid crystal panel 3, including a front plane with 32×16 thin film transistor driven pixels and a back plane.
2. Photo sensor array 1, having 12 horizontal photo sensors to detect the horizontal position of the light source and 6 vertical photo sensors to detect vertical position of the light source and further having sufficient A/D channels for reading input signals of the 18 photo sensors.
3. Microcontroller 2, which has 10 or more GPIOs, a serial communication interface, a reset input, an interrupt input and two A/D channels.
4. Active LCD matrix driver 5, which can has serial interfaces for communicating with the microcontroller 2 and driving the thin film LCD panel with 32×16 pixels and the back plane.
5. Keypad 4, which has a mode selection key, a “+” key, a “−” key and a reset key. The mode selection key allows the user to select one of the 5 operating modes. The + key and − key allow the user to move up the activated pixels on the liquid crystal panel. The reset key allows the user to reset the adaptive sun visor to its default operating state by starting a control circuit. In the passive LCD matrix, two groups of pixels are activated based on the output information from the sensor array.

Embodiment 4 can operate in the following modes:
1. 3×3 mode. Microcontroller 2 activates two groups of pixels. Each group has 9 pixels arranged in 3 rows and 3 columns. The center pixel in each group is driven to its lowest transparency, while the other 8 pixels are driven to 30% transparency of the center pixel.
2. 4×4 mode. Microcontroller 2 activates two groups of pixels. Each group has 16 pixels arranged in 4 rows and 4 columns. The 4 center pixels in each group are driven to the lowest transparency, while the other 12 pixels are driven to 30% transparency of the center pixel.
3. 5×5 mode. Microcontroller 2 activates two groups of pixels. Each group has 25 pixels arranged in 5 rows and 5 columns. The center pixel in each group is driven to the lowest transparency, the 8 pixels adjacent to the center pixel are driven to 20% transparency of the center pixel, and the rest 16 pixels are driven to 40% transparency of the center pixel.
4. 6×6 mode. Microcontroller 2 activates two groups of pixels. Each group has 36 pixels arranged in 6 rows and 6 columns. The 4 center pixels in each group are driven to the lowest transparency, the 12 pixels adjacent to the 4 center pixels are driven to 20% transparency of the center pixel, and the rest 20 pixels are driven to 40% transparency of the center pixel.
5. 7×7 mode. Microcontroller 2 activates two groups of pixels. Each group has 49 pixels arranged in 7 rows and 7 columns. The center pixel in each group is driven to the lowest transparency, the 8 pixels adjacent to the center pixel are driven to 20% transparency, the next 16 pixels are driven to 40% transparency, and the rest 24 pixels are driven to 60% transparency.

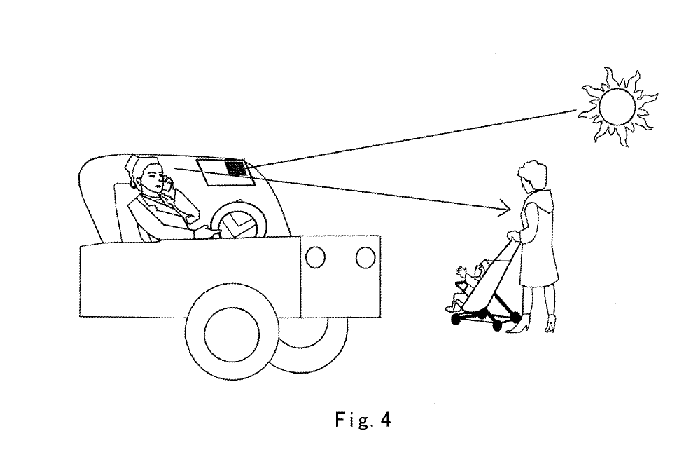

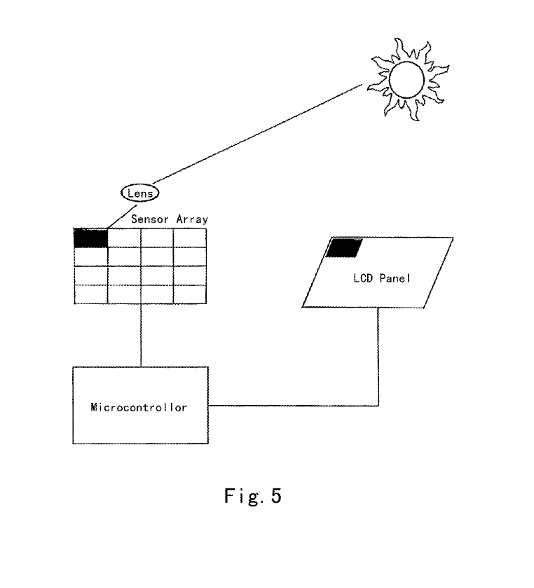

As shown in FIG. 4, the adaptive sun visor of the present invention can selectively blocking sunlight without blocking the driver's view. Thus, the driver can have a fine view of the objects in front of the car. On the other hand, as shown in FIG. 3, a traditional sun visor, when blocking disturbing sunlight, may inevitably block the view of the driver for objects in front of the car. It is dangerous when the driver cannot have a good view of objects in front of the car.

The forgoing description conveys the objectives and advantages of some embodiments of the present invention, which is also illustrated in FIG. 5. Different embodiments, however, may be made of the inventive concept of this invention.

1-13. (canceled)

14. An adaptive sun visor, comprising:
a photo sensor array assembly to detect offending light source;
a liquid crystal panel with a number of pixels;
a keypad; and
a microcontroller configured to selectively activate pixels on the liquid crystal panel based on inputs from the photo sensor array assembly and the keypad.

15. The adaptive sun visor set forth in claim 14, wherein the microcontroller comprises at least one general input/output, at least one serial interface, at least one reset input, at least one interrupt input, and at least one A/D channel.

16. The adaptive sun visor set forth in claim 14, wherein the microcontroller comprises a plurality of input/output interfaces, a keypad interface and an interface to drive the liquid crystal panel.

17. The adaptive sun visor set forth in claim 15, wherein the microcontroller comprises a plurality of input/output interfaces, a keypad interface and an interface to drive the liquid crystal panel.

18. The adaptive sun visor set forth in claim 14, wherein the photo sensor array assembly comprises a vertical photo sensor array, a horizontal photo sensor array, or a combination thereof.

19. The adaptive sun visor set forth in claim 14, wherein the photo sensor array assembly comprises a plurality of A/D channels for reading input signals from photo sensors.

20. The adaptive sun visor set forth in claim 18, wherein the photo sensor array assembly comprises a plurality of A/D channels for reading input signals from photo sensors.

21. The adaptive sun visor set forth in claim 14, wherein the photo sensor array assembly comprises an optical filter, photosensitive cover glass, one or more cylindrical lens, a linear photo sensor array, and an interface circuit to the microcontroller.

22. The adaptive sun visor set forth in claim 18, wherein the photo sensor array assembly comprises an optical filter, photosensitive cover glass, one or more cylindrical lens, a linear photo sensor array, and an interface circuit to the microcontroller.

23. The adaptive sun visor set forth in claim 19, wherein the photo sensor array assembly comprises an optical filter, photosensitive cover glass, one or more cylindrical lens, a linear photo sensor array, and an interface circuit to the microcontroller.

24. The adaptive sun visor set forth in claim 20, wherein the photo sensor array assembly comprises an optical filter, photosensitive cover glass, one or more cylindrical lens, a linear photo sensor array, and an interface circuit to the microcontroller.

25. The adaptive sun visor set forth in claim 14, wherein the liquid crystal panel comprises a passive liquid crystal panel driver, which interfaces with the microcontroller and drives the strips in a front plane and the strips in a back plane of the liquid crystal panel.

26. The adaptive sun visor set forth in claim 14, wherein the liquid crystal panel comprises an active liquid crystal panel driver, which interfaces with the microcontroller and drives the pixels in a front plane of the liquid crystal panel.

27. The adaptive sun visor set forth in claim 14, wherein the pixels on the liquid crystal panel are in a transparent state when not activated, and the pixels on the liquid crystal panel are in a partially transparent or non-transparent state when activated.

28. The adaptive sun visor set forth in claim 25, wherein the pixels on the liquid crystal panel are in a transparent state when not activated, and the pixels on the liquid crystal panel are in a partially transparent or non-transparent state when activated.

29. The adaptive sun visor set forth in claims 16, wherein the pixels on the liquid crystal panel are in a transparent state when not activated, and the pixels on the liquid crystal panel are in a partially transparent or non-transparent state when activated.

30. The adaptive sun visor set forth in claim 14, wherein the front plane and back plane of the liquid crystal panel use laminated glass or plastic as substrates.

31. The adaptive sun visor set forth in claim 25, wherein the front plane and back plane of the liquid crystal panel use laminated glass or plastic as substrates.

32. The adaptive sun visor set forth in claim 26, wherein the front plane and back plane of the liquid crystal panel use laminated glass or plastic as substrates.

33. The adaptive sun visor set forth in claim 27, wherein the front plane and back plane of the liquid crystal panel use laminated glass or plastic as substrates.

34. The adaptive sun visor set forth in claim 14, wherein the keypad has a mode select key, a “+” key, a “−” key and a reset key.
